(19) United States
(12) Patent Application Publication
(10) Pub. No.: US 2023/0185061 A1
(43) Pub. Date: Jun. 15, 2023

(54) OPTICAL LENS ASSEMBLY AND ELECTRONIC DEVICE

(71) Applicant: Ningbo Sunny Automotive Optech Co., Ltd., Ningbo City (CN)

(72) Inventors: Dongfang Wang, Ningbo City (CN); Aolin Ma, Ningbo City (CN); Bo Yao, Ningbo City (CN)

(21) Appl. No.: 18/106,422

(22) Filed: Feb. 6, 2023

Related U.S. Application Data
(63) Continuation of application No. PCT/CN2021/120752, filed on Sep. 26, 2021.

(30) Foreign Application Priority Data
Aug. 5, 2020 (CN) 202010776133.3

(51) Int. Cl. G02B 13/00; G02B 9/62

(52) U.S. Cl. CPC G02B 13/0045; G02B 9/62; G02B 13/006

(57) ABSTRACT

Disclosed are an optical lens assembly and an electronic device. The optical lens assembly sequentially comprises, from an object side to an image side along an optical axis, a first lens having a negative refractive power, with an object-side surface thereof being a convex surface, and an image-side surface thereof being a concave surface; a second lens having a negative refractive power, with an object-side surface thereof being a concave surface, and an image side surface thereof being a convex surface; a third lens having a positive refractive power, with an object-side surface thereof being a convex surface; a fourth lens having a positive refractive power, with an object-side surface thereof being a convex surface, and an image-side surface thereof being a convex surface; a fifth lens having a refractive power; a sixth lens having a focal power; and a seventh lens having a refractive power.

### CROSS-REFERENCE

This patent application is a continuation of international application No. PCT/CN2021/120752, filed on Sep. 26, 2021, which claims the priority from Chinese Patent Application No. 202010776133.3, filed on Aug. 5, 2020 and entitled “Optical Lens Assembly and Electronic Device,” the entire disclosure of which are hereby incorporated by reference.

### TECHNICAL FIELD

The present disclosure relates to the field of optical element, and more specifically to an optical lens assembly and an electronic device.

### BACKGROUND

In recent years, with the rapid development of automobile auxiliary driving systems, vehicle-mounted lens assemblies have become the eyes of vehicles to acquire external information, and play an irreplaceable role. In order to enable the vehicle-mounted lens assemblies to acquire information more precisely, optical lens assemblies needs to match larger chips having higher resolution, to improve the resolution quality of the lens assemblies.

Generally, in order to meet the requirements for higher imaging quality in the market, structures having more lenses are often selected. However, this will increase the cost, and seriously affect the miniaturization of the lens assemblies at the same time. For safety reasons, the vehicle-mounted lens assemblies applied in the field of autonomous driving have high requirements for stability and need to be able to cope with various harsh environments, to avoid significant degradation in the performance of the lens assemblies under different environments. Particularly, traffic light recognition technology is one of the applications of the vehicle-mounted lens assemblies in urban road detection. In order to precisely recognize signal lights of different colors, a lens assembly itself needs to have good chromatic aberrations.

### SUMMARY

In a first aspect, embodiments of the present disclosure provide an optical lens assembly, the optical lens assembly comprising, sequentially along an optical axis from an object side to an image side: a first lens, having a negative refractive power, an object-side surface of the first lens being a convex surface, and an image-side surface of the first lens being a concave surface; a second lens, having a negative refractive power, an object-side surface of the second lens being a concave surface, and an image-side surface of the second lens being a convex surface; a third lens, having a positive refractive power, an object-side surface of the third lens being a convex surface; a fourth lens, having a positive refractive power, an object-side surface of the fourth lens being a convex surface, and an image-side surface of the fourth lens being a convex surface; a fifth lens, having a refractive power; a sixth lens, having a refractive power; and a seventh lens, having a refractive power, wherein one of the fifth lens and the sixth lens has a positive refractive power, an other one of the fifth lens and the sixth lens has a negative refractive power, and the fifth lens and the sixth lens are cemented to form a cemented lens.

In an implementation, an image-side surface of the third lens is a convex surface.

In an implementation, the image-side surface of the third lens is a concave surface.

In an implementation, the fifth lens has a negative refractive power, an object-side surface of the fifth lens is a concave surface, and an image-side surface of the fifth lens is a concave surface.

In an implementation, the fifth lens has a negative refractive power, the object-side surface of the fifth lens is a convex surface, and the image-side surface of the fifth lens is a concave surface.

In an implementation, the fifth lens has a positive refractive power, the object-side surface of the fifth lens is a convex surface, and the image-side surface of the fifth lens is a convex surface.

In an implementation, the sixth lens has a positive refractive power, an object-side surface of the sixth lens is a convex surface, and an image-side surface of the sixth lens is a convex surface.

In an implementation, the sixth lens has a negative refractive power, the object-side surface of the sixth lens is a concave surface, and the image-side surface of the sixth lens is a concave surface.

In an implementation, the seventh lens has a positive refractive power, an object-side surface of the seventh lens is a convex surface at an area near the optical axis, and an image-side surface of the seventh lens is a concave surface at the area near the optical axis.

In an implementation, the seventh lens has a negative refractive power, the object-side surface of the seventh lens is a concave surface at the area near the optical axis, and the image-side surface of the seventh lens is a convex surface at the area near the optical axis.

In an implementation, the seventh lens has a negative refractive power, the object-side surface of the seventh lens is a concave surface at the area near the optical axis, and the image-side surface of the seventh lens is a concave surface at the area near the optical axis.

In an implementation, the seventh lens has a positive refractive power, the object-side surface of the seventh lens is a convex surface at the area near the optical axis, and the image-side surface of the seventh lens is a convex surface at the area near the optical axis.

In an implementation, the object-side surface of the seventh lens and the image-side surface of the seventh lens at least have one inflection point.

In an implementation, at least two of the second lens, the third lens, the fourth lens and the seventh lens have an aspheric surface.

In an implementation, a distance TTL from the object-side surface of the first lens to an image plane of the optical lens assembly on the optical axis and a total effective focal length F of the optical lens assembly satisfy: TTL/F≤9.

In an implementation, the distance TTL from the object-side surface of the first lens to the image plane of the optical lens assembly on the optical axis, an image height H corresponding to a maximal field-of-view FOV of the optical lens assembly and the maximal field-of-view FOV of the optical lens assembly satisfy: TTL/H/FOV≤0.1.

In an implementation, the maximal field-of-view FOV of the optical lens assembly, a maximal aperture D of the object-side surface of the first lens corresponding to the maximal field-of-view of the optical lens assembly and the image height H corresponding to the maximal field-of-view of the optical lens assembly satisfy: D/H/FOV≤0.025.

In an implementation, an effective focal length F+ of a lens having a positive refractive power in the cemented lens and an effective focal length F− of a lens having a negative refractive power in the cemented lens satisfy: 0.5≤|F+/F−|≤3.

In an implementation, an effective focal length F7 of the seventh lens and the total effective focal length F of the optical lens assembly satisfy: |F7/F|≥1.5.

In an implementation, a spacing distance T67 between the sixth lens and the seventh lens on the optical axis and the distance TTL from the object-side surface of the first lens to the image plane of the optical lens assembly on the optical axis satisfy: 0≤T67/TTL≤0.2.

In an implementation, a radius of curvature R3 of the object-side surface of the second lens, a radius of curvature R4 of the image-side surface of the second lens and a center thickness d3 of the second lens on the optical axis satisfy: |R3−R4−d3|≥1.5 mm.

In an implementation, the center thickness d3 of the second lens on the optical axis and the distance TTL from the object-side surface of the first lens to the image plane of the optical lens assembly on the optical axis satisfy: 0.05≤d3/TTL≤0.3.

In an implementation, the maximal field-of-view FOV of the optical lens assembly, the total effective focal length F of the optical lens assembly and the image height H corresponding to the maximal field-of-view of the optical lens assembly satisfy: (FOV×F)/H≤70.

In an implementation, a semi-diameter D3 of a maximal aperture of the object-side surface of the second lens corresponding to the maximal field-of-view of the optical lens assembly, a distance SAG3 from an intersection point of the object-side surface of the second lens and the optical axis to the maximal aperture of the object-side surface of the second lens on the optical axis, a semi-diameter D4 of a maximal aperture of the image-side surface of the second lens corresponding to the maximal field-of-view of the optical lens assembly, and a distance SAG4 from an intersection point of the image-side surface of the second lens and the optical axis to the maximal aperture of the image-side surface of the second lens on the optical axis satisfy: 0.5≤arctan(SAG3/D3)/arctan(SAG4/D4)≤3.

In an implementation, a refractive index Nd+ of the lens having the positive refractive power in the cemented lens and an abbe number Vd+ of the lens having the positive refractive power in the cemented lens satisfy: Vd+/Nd+≥40.

In a second aspect, embodiments of the present disclosure provide an optical lens assembly, the optical lens assembly comprising, sequentially along an optical axis from an object side to an image side: a first lens, having a negative refractive power, an object-side surface of the first lens being a convex surface, and an image-side surface of the first lens being a concave surface; a second lens, having a negative refractive power, an object-side surface of the second lens being a concave surface, and an image-side surface of the second lens being a convex surface; a third lens, having a positive refractive power, an object-side surface of the third lens being a convex surface; a fourth lens, having a positive refractive power, an object-side surface of the fourth lens being a convex surface, and an image-side surface of the fourth lens being a convex surface; a fifth lens, having a refractive power; a sixth lens, having a refractive power; and a seventh lens, having a refractive power, wherein a spacing distance T67 between the sixth lens and the seventh lens on the optical axis and a distance TTL from the object-side surface of the first lens to an image plane of the optical lens assembly on the optical axis satisfy: 0≤T67/TTL≤0.2.

In an implementation, one of the fifth lens and the sixth lens has a positive refractive power, an other one of the fifth lens and the sixth lens has a negative refractive power, and the fifth lens and the sixth lens are cemented to form a cemented lens.

In an implementation, an image-side surface of the third lens is a convex surface.

In an implementation, the image-side surface of the third lens is a concave surface.

In an implementation, the fifth lens has a negative refractive power, an object-side surface of the fifth lens is a concave surface, and an image-side surface of the fifth lens is a concave surface.

In an implementation, the fifth lens has a negative refractive power, the object-side surface of the fifth lens is a convex surface, and the image-side surface of the fifth lens is a concave surface.

In an implementation, the fifth lens has a positive refractive power, the object-side surface of the fifth lens is a convex surface, and the image-side surface of the fifth lens is a convex surface.

In an implementation, the sixth lens has a positive refractive power, an object-side surface of the sixth lens is a convex surface, and an image-side surface of the sixth lens is a convex surface.

In an implementation, the sixth lens has a negative refractive power, the object-side surface of the sixth lens is a concave surface, and the image-side surface of the sixth lens is a concave surface.

In an implementation, the seventh lens has a positive refractive power, an object-side surface of the seventh lens is a convex surface at an area near the optical axis, and an image-side surface of the seventh lens is a concave surface at the area near the optical axis.

In an implementation, the seventh lens has a negative refractive power, the object-side surface of the seventh lens is a concave surface at the area near the optical axis, and the image-side surface of the seventh lens is a convex surface at the area near the optical axis.

In an implementation, the seventh lens has a negative refractive power, the object-side surface of the seventh lens is a concave surface at the area near the optical axis, and the image-side surface of the seventh lens is a concave surface at the area near the optical axis.

In an implementation, the seventh lens has a positive refractive power, the object-side surface of the seventh lens is a convex surface at the area near the optical axis, and the image-side surface of the seventh lens is a convex surface at the area near the optical axis.

In an implementation, the object-side surface of the seventh lens and the image-side surface of the seventh lens at least have one inflection point.

In an implementation, at least two of the second lens, the third lens, the fourth lens and the seventh lens have an aspheric surface.

In an implementation, the distance TTL from the object-side surface of the first lens to the image plane of the optical lens assembly on the optical axis and a total effective focal length F of the optical lens assembly satisfy: TTL/F≤9.

In an implementation, the distance TTL from the object-side surface of the first lens to the image plane of the optical lens assembly on the optical axis, an image height H corresponding to a maximal field-of-view of the optical lens assembly and the maximal field-of-view FOV of the optical lens assembly satisfy: TTL/H/FOV≤0.1.

In an implementation, the maximal field-of-view FOV of the optical lens assembly, a maximal aperture D of the object-side surface of the first lens corresponding to the maximal field-of-view of the optical lens assembly and the image height H corresponding to the maximal field-of-view of the optical lens assembly satisfy: D/H/FOV≤0.025.

In an implementation, an effective focal length F+ of a lens having a positive refractive power in the cemented lens and an effective focal length F− of a lens having a negative refractive power in the cemented lens satisfy: 0.5≤|F+/F−|≤3.

In an implementation, an effective focal length F7 of the seventh lens and the total effective focal length F of the optical lens assembly satisfy: |F7/F|≥1.5.

In an implementation, a radius of curvature R3 of the object-side surface of the second lens, a radius of curvature R4 of the image-side surface of the second lens and a center thickness d3 of the second lens on the optical axis satisfy: |R3−R4−d3−≥1.5 mm.

In an implementation, the center thickness d3 of the second lens on the optical axis and the distance TTL from the object-side surface of the first lens to the image plane of the optical lens assembly on the optical axis satisfy: 0.05≤d3/TTL≤0.3.

In an implementation, the maximal field-of-view FOV of the optical lens assembly, the total effective focal length F of the optical lens assembly and the image height H corresponding to the maximal field-of-view FOV of the optical lens assembly satisfy: (FOV×F)/H≤70.

In an implementation, a semi-diameter D3 of a maximal aperture of the object-side surface of the second lens corresponding to the maximal field-of-view of the optical lens assembly, a distance SAG3 from an intersection point of the object-side surface of the second lens and the optical axis to the maximal aperture of the object-side surface of the second lens on the optical axis, a semi-diameter D4 of a maximal aperture of the image-side surface of the second lens corresponding to the maximal field-of-view of the optical lens assembly, and a distance SAG4 from an intersection point of the image-side surface of the second lens and the optical axis to the maximal aperture of the image-side surface of the second lens on the optical axis satisfy: 0.5≤arctan(SAG3/D3)/arctan(SAG4/D4)≤3.

In an implementation, a refractive index Nd+of the lens having the positive refractive power in the cemented lens and an abbe number Vd+ of the lens having the positive refractive power in the cemented lens satisfy: Vd+/Nd+≥40.

In a third aspect, embodiments of the present disclosure provide an electronic device, the electronic device comprising the optical lens assembly according to any one of claims 1-50 and an imaging element used to convert an optical image formed by the optical lens assembly into an electrical signal.

The present disclosure uses seven lenses. By optimizing the shapes and refractive powers of the lenses, the optical lens assembly has at least one beneficial effect such as high resolution, miniaturization, small distortions, a low cost, and good temperature performance.

### BRIEF DESCRIPTION OF THE DRAWINGS

In combination with the accompanying drawings, other features, objectives and advantages of the present disclosure will become more apparent through the following detailed description for non-limiting embodiments. In the accompanying drawings:

FIG. 1 is a schematic structural diagram of an optical lens assembly according to Embodiment 1 of the present disclosure;

FIG. 2 is a schematic structural diagram of an optical lens assembly according to Embodiment 2 of the present disclosure;

FIG. 3 is a schematic structural diagram of an optical lens assembly according to Embodiment 3 of the present disclosure;

FIG. 4 is a schematic structural diagram of an optical lens assembly according to Embodiment 4 of the present disclosure;

FIG. 5 is a schematic structural diagram of an optical lens assembly according to Embodiment 5 of the present disclosure;

FIG. 6 is a schematic structural diagram of an optical lens assembly according to Embodiment 6 of the present disclosure;

FIG. 7 is a schematic structural diagram of an optical lens assembly according to Embodiment 7 of the present disclosure;

FIG. 8 is a schematic structural diagram of an optical lens assembly according to Embodiment 8 of the present disclosure; and

FIG. 9 is a schematic diagram of a sagittal height of an object-side surface of a lens according to the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. A surface of each lens that is closest to a photographed object is referred to as the object-side surface of the lens, and a surface of the each lens that is closest to an image side is referred to as the image-side surface of the lens.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list. Further, the use of “may,” when describing the implementations of the present disclosure, relates to “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The present disclosure will be described below in detail with reference to the accompanying drawings and in combination with the embodiments.

Features, principles and other aspects of the present disclosure are described below in detail.

In exemplary implementations, an optical lens assembly includes, for example, seven lenses (i.e., a first lens, a second lens, a third lens, a fourth lens, a fifth lens, a sixth lens and a seventh lens) having refractive powers. The seven lenses are arranged in sequence along an optical axis from an object side to an image side.

In the exemplary implementations, the optical lens assembly may further include a photosensitive element disposed on an image plane. Alternatively, the photosensitive element disposed on the image plane may be a charge coupled device (CCD) or complementary metal-oxide semiconductor element (CMOS).

In the exemplary implementations, the first lens may have a negative refractive power. The first lens may have a convex-concave shape. The setting for the refractive power of the first lens can prevent the light from the object side from diverging too much, which is conducive to controlling the diameter of a rear lens and realizing a miniaturization design. Through the setting for the shape of the first lens, light in a large field of view can be collected as much as possible to enter the rear optical system, increasing the amount of light passing. The object-side surface of the first lens is designed to be a convex surface, which is conducive to the sliding of water droplets and reducing the influence on images in actual use environments such as rainy and snowy weather. Preferably, the first lens has a high refractive index (e.g., Nd1≥1.7) and high hardness, which is conducive to reducing the diameter of the front end and improving the imaging quality.

In the exemplary implementations, the second lens may have a negative refractive power. The second lens may have a convex-concave shape. The setting for the refractive power of the second lens is conducive to diverging the light passing through the first lens. The setting for the shape of the second lens helps the light stably transit to the rear optical system. Preferably, the second lens has an aspheric surface, which can improve the resolution of the lens assembly.

In the exemplary implementations, the third lens may have a positive refractive power. The third lens may have a convex-convex shape or convex-concave shape. The settings for the refractive power and shape of the third lens are conducive to the convergence of light. The third lens is preferably made of a material with a high refractive index (Nd3≥1.65), which is conducive to reducing the diameter of the front end and improving the imaging quality. Preferably, the third lens has an aspheric surface, which can improve the resolution of the lens assembly.

In the exemplary implementations, the fourth lens may have a positive refractive power. The fourth lens may have a convex-convex shape. The settings for the refractive power and shape of the fourth lens are conducive to the convergence of light, which makes the light stably transit to the rear optical system. By controlling the effective focal length of the fourth lens, the light trend from the first lens to the fourth lens can be controlled, which makes the structure of the system compact. Preferably, the fourth lens has an aspheric surface, which can improve the resolution of the lens assembly.

In the exemplary implementations, the seventh lens may have a positive or negative refractive power. The seventh lens may have a concave-convex, convex-concave, convex-convex or concave-concave shape. Preferably, the seventh lens has an aspheric surface, which can further improve a resolution quality and correct aberrations.

In the exemplary implementations, at least two of the second lens, the third lens, the fourth lens and the seventh lens may have an aspheric surface, which can improve the resolution of the lens assembly.

In the exemplary implementations, the optical lens assembly according to the present disclosure may satisfy: TTL/F≤9. Here, TTL is a distance from the object-side surface of the first lens to an image plane of the optical lens assembly on the optical axis, and F is a total effective focal length F of the optical lens assembly. More specifically, TTL and F may further satisfy: TTL/F≤8.5. Satisfying TTL/F≤9 is conducive to implementing miniaturization.

In the exemplary implementations, the optical lens assembly according to the present disclosure may satisfy: TTL/H/FOV≤0.1. Here, TTL is the distance from the object-side surface of the first lens to the image plane of the optical lens assembly on the optical axis, H is an image height corresponding to a maximal field-of-view of the optical lens assembly, and FOV is the maximal field-of-view of the optical lens assembly. More specifically, TTL, H and FOV may further satisfy: TTL/H/FOV≤0.05. Satisfying TTL/H/FOV≤0.1 is conducive to the miniaturization, which can make the size of the lens assembly smaller in the situation of the same image plane and the same image height.

In the exemplary implementations, the optical lens assembly according to the present disclosure may satisfy: D/H/FOV≤0.025. Here, D is a maximal aperture of the object-side surface of the first lens corresponding to the maximal field-of-view of the optical lens assembly, H is the image height corresponding to the maximal field-of-view of the optical lens assembly, and FOV is the maximal field-of-view of the optical lens assembly. More specifically, D, H and FOV may further satisfy: D/H/FOV≤0.02. Satisfying D/H/FOV≤0.025 is conducive to the small diameter of the front end.

In the exemplary implementations, the optical lens assembly according to the present disclosure may satisfy: 0.5≤|F+/F−|≤3. Here, F+ is an effective focal length of a lens having a positive refractive power in a cemented lens and F− is an effective focal length of a lens having a negative refractive power in the cemented lens. More specifically, F+ and F− may further satisfy: 0.8≤|F+/F−|≤2.5. Satisfying 0.5≤|F+/F−|≤3 makes the focal length values of the lenses in the cemented lens close, which is conducive to the smooth transition of the light and correcting chromatic aberrations.

In the exemplary implementations, the optical lens assembly according to the present disclosure may satisfy: |F7/F|≥1.5. Here, F7 is an effective focal length of the seventh lens, and F is the total effective focal length of the optical lens assembly. More specifically, F7 and F may further satisfy: |F7/F|≥2. Satisfying |F7/F|≥1.5 is conducive to correcting chromatic aberrations.

In the exemplary implementations, the optical lens assembly according to the present disclosure may satisfy: 0≤T67/TTL≤0.2. Here, T67 is a spacing distance between the sixth lens and the seventh lens on the optical axis, and TTL is the distance from the object-side surface of the first lens to the image plane of the optical lens assembly on the optical axis. More specifically, T67 and TTL may further satisfy: 0.01≤T67/TTL≤0.1. Satisfying 0≤T67/TTL≤0.2 is conducive to the assembling of the optical lens assembly and improving ghost images.

In the exemplary implementations, the optical lens assembly according to the present disclosure may satisfy: |R3−R4−d3|≥1.5 mm. Here, R3 is a radius of curvature of the object-side surface of the second lens, R4 is a radius of curvature of the image-side surface of the second lens, and d3 is a center thickness of the second lens on the optical axis. More specifically, R3, R4 and d3 may further satisfy: |R3−R4−d3|≥1.8 mm. Satisfying |R3−R4−d3|≥1.5 mm is conducive to the smooth transition of the light and to the processing.

In the exemplary implementations, the optical lens assembly according to the present disclosure may satisfy: 0.05≤d3/TTL≤0.3. Here, d3 is the center thickness of the second lens on the optical axis, and TTL is the distance from the object-side surface of the first lens to the image plane of the optical lens assembly on the optical axis. More specifically, d3 and TTL may further satisfy: 0.1≤d3/TTL≤0.25. Satisfying 0.05≤d3/TTL≤0.3 helps the light smoothly pass through the second lens.

In the exemplary implementations, the optical lens assembly according to the present disclosure may satisfy: (FOV×F)/H≤70. Here, FOV is the maximal field-of-view of the optical lens assembly, F is the total effective focal length of the optical lens assembly, and H is the image height corresponding to the maximal field-of-view of the optical lens assembly. More specifically, FOV, F and H may further satisfy: (FOV×F)/H≤65. Satisfying (FOV×F)/H≤70 is beneficial for the optical lens assembly to have small distortions, and thus the optical lens assembly can match larger chips.

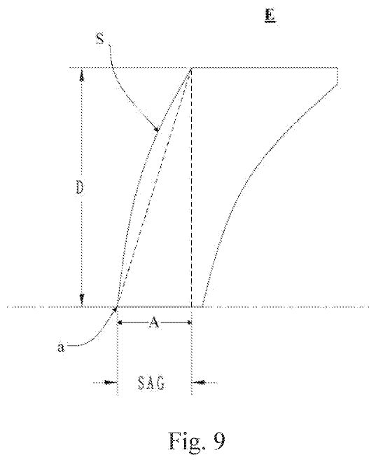

FIG. 9 is a schematic diagram of a sagittal height SAG of an object-side surface S of a lens E according to the present disclosure. D is a semi-diameter of a maximal aperture of the object-side surface S of the lens E corresponding to the maximal field-of-view of the optical lens assembly, and the sagittal height SAG is a distance A from an intersection point a of the object-side surface S of the lens E and the optical axis to the maximal aperture of the object-side surface S of the lens E on the optical axis. In the exemplary implementations, the optical lens assembly according to the present disclosure may satisfy: 0.5≤arctan(SAG3/D3)/arctan(SAG4/D4)≤3. Here, D3 is a semi-diameter of a maximal aperture of the object-side surface of the second lens corresponding to the maximal field-of-view of the optical lens assembly, SAG3 is a distance from an intersection point of the object-side surface of the second lens and the optical axis to the maximal aperture of the object-side surface of the second lens on the optical axis, D4 is a semi-diameter of a maximal aperture of the image-side surface of the second lens corresponding to the maximal field-of-view of the optical lens assembly, and SAG4 is a distance from an intersection point of the image-side surface of the second lens and the optical axis to the maximal aperture of the image-side surface of the second lens on the optical axis. More specifically, SAG3, D3, SAG4 and D4 may further satisfy: 1≤arctan(SAG3/D3)/arctan(SAG4/D4)≤2.5. Satisfying 0.5≤arctan(SAG3/D3)/arctan(SAG4/D4)≤3 is conducive to the smooth transition of peripheral light and the reduction of the sensitivity of the lens.

In the exemplary implementations, the optical lens assembly according to the present disclosure may satisfy: Vd+/Nd+≥40. Here, Nd+ is a refractive index of the lens having the positive refractive power in the cemented lens, and Vd+ is an abbe number of the lens having the positive refractive power in the cemented lens. More specifically, Vd+ and Nd+ may further satisfy: Vd+/Nd+≥50. When Vd+/Nd+≥40 is satisfied, the lens having the positive refractive power in the cemented lens is preferably made of a material having an ultra low refractive index and an ultra low chromatic dispersion, which is conducive to correcting chromatic aberrations.

In the exemplary implementations, a diaphragm used to restrict light beams may be disposed between the third lens and the fourth lens to further improve the imaging quality of the optical lens assembly. Disposing the diaphragm between the third lens and the fourth lens is conducive to increasing the diameter of the diaphragm, and effectively converging the light entering the optical lens assembly, to reduce the diameter of the lens. In the implementations of the present disclosure, the diaphragm may be disposed near the image-side surface of the third lens, or near the object-side surface of the fourth lens. However, it should be noted that the positions of the diaphragm disclosed here are only examples, rather than limitations. In alternative implementations, the diaphragm may be disposed at other positions according to actual needs.

In the exemplary implementations, the optical lens assembly according to the present disclosure may further include an optical filter disposed between the seventh lens and the image plane, to filter light with different wavelengths. The optical lens assembly according to the present disclosure may further include a protective glass disposed between the seventh lens and the image plane, to prevent the elements (e.g., chips) on the image side of the optical lens assembly from being damaged.

As known to those skilled in the art, the cemented lens can be used to reduce or eliminate chromatic aberrations to the greatest extent. The use of the cemented lens in the optical lens assembly can improve the imaging quality and reduce the reflection loss of light energy, thereby achieving high resolution and improving the image clarity of lens assembly. In addition, the use of the cemented lens can simplify the assembling procedures in the process of manufacturing the lens assembly.

In the exemplary implementations, the fifth lens and the sixth lens are cemented to form a cemented lens. The fifth lens and the sixth lens have opposite refractive powers. For example, if the fifth lens has a positive refractive power, then the sixth lens has a negative refractive power; or if the fifth lens has a negative refractive power, then the sixth lens has a positive refractive power. The lens having a positive refractive power is preferably a lens made of a material having a low refractive index and a low chromatic dispersion, which is conducive to eliminating chromatic aberrations. The fifth lens having a concave image-side surface and the sixth lens having a convex object-side surface are cemented, or the fifth lens having a convex image-side surface and the sixth lens having a concave object-side surface are cemented, which is conducive to correcting various aberrations of the optical system, and improving the resolution of the system and optimizing optical performance such as distortion and CRA under the premise that the compact structure of the optical system is achieved. The cementing approach between the above lenses has at least one of the following advantages: reducing the chromatic aberrations of the lenses, reducing a tolerance sensitivity, and balancing the overall chromatic aberration of the system through residual chromatic aberrations; reducing the spacing distance between the two lenses, thereby reducing the total length of the system; reducing the assembly part between lenses, thereby reducing the procedures and cost; reducing the tolerance sensitivity problem of a lens unit caused by the tilt/eccentricity in the assembling process, thereby improve the production yield; reducing the loss in the amount of light caused by the reflection between lenses, thereby improving illumination; and further reducing a field curvature, thereby effectively correcting the off-axis point aberration of the optical lens assembly. Such cementing design shares the overall chromatic aberration correction of the system, the aberrations are effectively corrected to improve the resolution. The cementing design makes the optical system compact as a whole, thereby meeting the miniaturization requirement.

In the exemplary implementations, the first lens, the second lens, the third lens, the fourth lens, the fifth lens, the sixth lens and the seventh lens can all have an aspheric surface. The aspheric lens is characterized in that the curvature continuously changes from the center of the lens to the periphery of the lens. Different from a spherical lens having a constant curvature from the center of the lens to the periphery of the lens, the aspheric lens has a better radius-of-curvature characteristic, and has advantages of improving the distortion aberration and improving the astigmatic aberration. The use of the aspheric lens can eliminate as much as possible the aberrations that occur during the imaging, thereby improving the imaging quality. The setting of the aspheric lens helps to correct the aberrations of the system and improve the resolution. Specifically, at least one of the first lens, the second lens, the third lens, the fourth lens, the fifth lens, the sixth lens and the seventh lens is an aspheric lens, which is conducive to improving the resolution quality of the optical system.

Through the reasonable settings for the shapes and refractive powers of the lenses, in the situation where only seven lenses are used, the optical lens assembly according to the above implementations of the present disclosure enables the optical system to achieve at least one beneficial effect such as small chromatic aberrations and high resolution (which can be up to 8 million pixels or more), miniaturization, small distortions, a small front-end diameter, a small ghost image and a good imaging quality. At the same time, the optical system also takes into account the low-cost requirements for a small lens size, a low sensitivity and a high production yield. The optical lens assembly also has a long focal length, and the central area thereof has large angular resolution, which can improve the recognition of environmental objects and enlarge the detection area in the central part with pertinence. At the same time, the optical lens assembly has good temperature adaptability performance, a small change in imaging effects under high and low temperature environments, and a stable imaging quality.

The optical lens assembly according to the above implementations of the present disclosure is provided with the cemented lens to share the overall chromatic aberration correction of the system, which is not only conducive to correcting the aberration of the system, improving the resolution quality of the system and reducing the problem of matching sensitivity, but also conducive to making the overall structure of the optical system compact and meeting the miniaturization requirement.

In the exemplary implementations, the first to seventh lenses in the optical lens assembly may all be made of glass. The optical lens assembly made of glass can suppress the deviation of the back focus of the optical lens caused by a temperature change, to improve the stability of the system. At the same time, the use of the glass material can avoid the influence on the normal use of the lens assembly due to the blurred image of the lens assembly caused by the change of the high and low temperatures in the use environment. Specifically, when the resolution quality and the reliability are the focus, the first to seventh lenses may all be glass aspherical lenses. Clearly, in application scenarios where there are low requirements for the temperature stability, the first to seventh lenses in the optical lens assembly can alternatively all be made of plastic. Using the plastic to make the optical lens assembly can effectively reduce the production cost.

However, it should be understood by those skilled in the art that the various results and advantages described in the present specification may be obtained by changing the number of the lenses constituting the optical lens assembly without departing from the technical solution claimed by the present disclosure. For example, although the optical lens assembly having seven lenses is described as an example in the implementations, the optical lens assembly is not limited to including the seven lenses. If desired, the optical lens assembly may also include other numbers of lenses.

Specific embodiments of the optical lens assembly that may be applicable to the above implementations are further described below with reference to the accompanying drawings.

### Embodiment 1

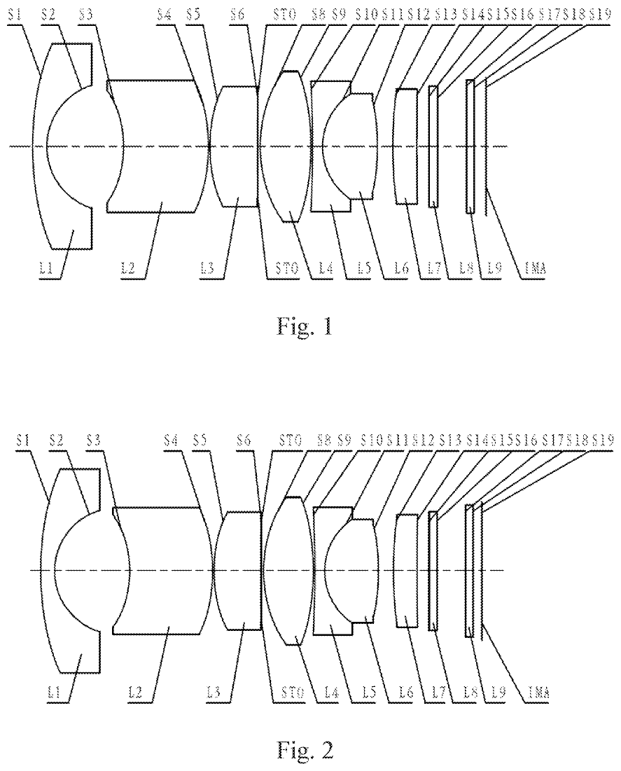

An optical lens assembly according to Embodiment 1 of the present disclosure is described below with reference to FIG. 1. FIG. 1 is a schematic structural diagram of the optical lens assembly according to Embodiment 1 of the present disclosure.

As shown in FIG. 1, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a dual-concave lens having a negative refractive power, an object-side surface S10 of the fifth lens L5 is a concave surface, and an image-side surface S11 of the fifth lens L5 is a concave surface. The sixth lens L6 is a dual-convex lens having a positive refractive power, an object-side surface S11 of the sixth lens L6 is a convex surface, and an image-side surface S12 of the sixth lens L6 is a convex surface. The seventh lens L7 has a positive refractive power and is a convex-concave lens at an area near the optical axis, an object-side surface S13 of the seventh lens L7 is a convex surface at the area near the optical axis, and an image-side surface S14 of the seventh lens L7 is a concave surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the image-side surface S6 of the third lens L3.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 1 shows a radius of curvature R, a thickness d/distance T (it should be understood that the thickness d/distance T in the row of S1 refers to the center thickness d1 of the first lens L1, and the thickness d/distance T in the row of S2 refers to the spacing distance between the first lens L1 and the second lens L2, and so on), a refractive index Nd and an abbe number Vd of each lens of the optical lens assembly in Embodiment 1.

TABLE 1

| | radius of | thickness d/ | refractive | abbe |
|---|---|---|---|---|
| surface | curvature R | distance T | index | number |
| number | (mm) | (mm) | Nd | Vd |
| S1 | 18.6988 | 0.9459 | 1.80 | 46.57 |
| S2 | 4.3041 | 5.1238 | | |
| S3 | −6.9412 | 5.6589 | 1.82 | 46.57 |
| S4 | −10.6271 | 0.0965 | | |
| S5 | 10.0451 | 3.1718 | | |
| S6 | −63.1732 | 0.0241 | 1.69 | 31.08 |
| STO | infinite | 0.1664 | | |
| S8 | 8.9297 | 3.3863 | 1.59 | 68.53 |
| S9 | −14.9080 | 0.0965 | | |
| S10 | −90.1486 | 0.6757 | 1.85 | 23.79 |
| S11 | 4.2491 | 3.6568 | 1.50 | 81.59 |
| S12 | −14.5255 | 1.0337 | | |
| S13 | 14.4243 | 1.5970 | 1.69 | 31.08 |
| S14 | 21.2501 | 0.8204 | | |
| S15 | infinite | 0.5500 | 1.52 | 64.21 |
| S16 | infinite | 1.9409 | | |
| S17 | infinite | 0.5000 | 1.52 | 64.21 |
| S18 | infinite | 0.8172 | | |
| S19(IMA) | infinite | — | | |

In Embodiment 1, the object-side surface S5 and the image-side surface S6 of the third lens L3 and the object-side surface S13 and the image-side surface S14 of the seventh lens L7 may all be aspheric surfaces, and the surface type x of each aspheric lens may be defined using, but not limited to, the following formula:

$$x = \frac{c {h}^{2}}{1 + \sqrt{1 - ( k + 1 ) {c}^{2} {h}^{2}}} + \sum A i {h}^{i} . \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface. Table 2 below gives the conic coefficients k and the high-order coefficients A4, A6, A8, A10, Al2, A14 and A16 applicable to the aspheric surfaces S5, S6, S13 and S14 in Embodiment 1.

TABLE 2

| surface | | | | | | | | |
|---|---|---|---|---|---|---|---|---|
| number | k | A4 | A6 | A8 | A10 | A12 | A14 | A16 |
| S5 | 0.3293 | 2.5755E−05 | 6.8127E−06 | −1.0898E−06 | 2.3276E−07 | −2.2212E−08 | 1.0819E−09 | −2.1174E−11 |
| S6 | −153.1859 | 5.5603E−04 | −2.3146E−05 | 9.4222E−06 | −1.2849E−06 | 9.2896E−08 | −2.7591E−09 | 5.0835E−12 |
| S13 | 13.0558 | −1.8693E−03 | −2.8700E−05 | −7.7638E−06 | 2.0232E−06 | −2.5180E−07 | 1.6134E−08 | −4.7997E−10 |
| S14 | −103.9655 | 2.4359E−04 | −2.8649E−04 | 4.6375E−05 | −5.5629E−06 | 4.2192E−07 | −1.7670E−08 | 3.0788E−10 |

### Embodiment 2

An optical lens assembly according to Embodiment 2 of the present disclosure is described below with reference to FIG. 2. FIG. 2 is a schematic structural diagram of the optical lens assembly according to Embodiment 2 of the present disclosure.

As shown in FIG. 2, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a dual-concave lens having a negative refractive power, an object-side surface S10 of the fifth lens L5 is a concave surface, and an image-side surface S11 of the fifth lens L5 is a concave surface. The sixth lens L6 is a dual-convex lens having a positive refractive power, an object-side surface S11 of the sixth lens L6 is a convex surface, and an image-side surface S12 of the sixth lens L6 is a convex surface. The seventh lens L7 has a positive refractive power and is a convex-concave lens at an area near the optical axis, an object-side surface S13 of the seventh lens L7 is a convex surface at the area near the optical axis, and an image-side surface S14 of the seventh lens L7 is a concave surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the image-side surface S6 of the third lens L3.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 3 shows a radius of curvature R, a thickness d/distance T, a refractive index Nd and an abbe number Vd of each lens of the optical lens assembly in Embodiment 2. Table 4 shows the conic coefficients and the high-order coefficients applicable to the aspheric surfaces in Embodiment 2. Here, the surface type of each aspheric surface may be defined using the formula (1) given in Embodiment 1.

TABLE 3

| | radius of | thickness d/ | refractive | abbe |
|---|---|---|---|---|
| surface | curvature R | distance T | index | number |
| number | (mm) | (mm) | Nd | Vd |
| S1 | 18.4337 | 0.9331 | 1.80 | 46.57 |
| S2 | 4.2475 | 5.0538 | | |
| S3 | −6.8825 | 5.5800 | 1.62 | 63.41 |
| S4 | −10.4519 | 0.0952 | | |
| S5 | 9.8903 | 3.1555 | 1.69 | 31.08 |
| S6 | −62.1984 | 0.0238 | | |
| STO | infinite | 0.1642 | | |
| S8 | 8.7886 | 3.3447 | 1.59 | 68.53 |
| S9 | −14.7358 | 0.0952 | | |
| S10 | −88.6058 | 0.6665 | 1.85 | 23.79 |
| S11 | 4.1892 | 3.6138 | 1.49 | 81.59 |
| S12 | −14.3469 | 1.0235 | | |
| S13 | 14.2465 | 1.5847 | 1.69 | 31.08 |
| S14 | 20.6251 | 0.8093 | | |
| S15 | infinite | 0.5500 | 1.52 | 64.21 |
| S16 | infinite | 1.9146 | | |
| S17 | infinite | 0.5000 | 1.52 | 64.21 |
| S18 | infinite | 0.5841 | | |
| S19(IMA) | infinite | — | | |

TABLE 4

| surface | | | | | | | | |
|---|---|---|---|---|---|---|---|---|
| number | k | A4 | A6 | A8 | A10 | A12 | A14 | A16 |
| S5 | 1.2211 | 2.8494E−05 | 7.1240E−06 | −1.2034E−06 | 2.6323E−07 | −2.5756E−08 | 1.2980E−09 | −2.5336E−11 |
| S6 | −149.0383 | 5.7112E−04 | −2.4717E−05 | 1.0390E−05 | −1.4498E−06 | 1.0818E−07 | −3.2687E−09 | 7.6056E−12 |
| S13 | 13.0167 | −1.9518E−03 | −3.1210E−05 | −8.5964E−06 | 2.2814E−06 | −2.9284E−07 | 1.9330E−08 | −5.6580E−10 |
| S14 | −101.6136 | 2.5697E−04 | −3.0632E−04 | 5.1054E−05 | −6.2848E−06 | 4.9056E−07 | −2.1060E−08 | 3.7726E−10 |

### Embodiment 3

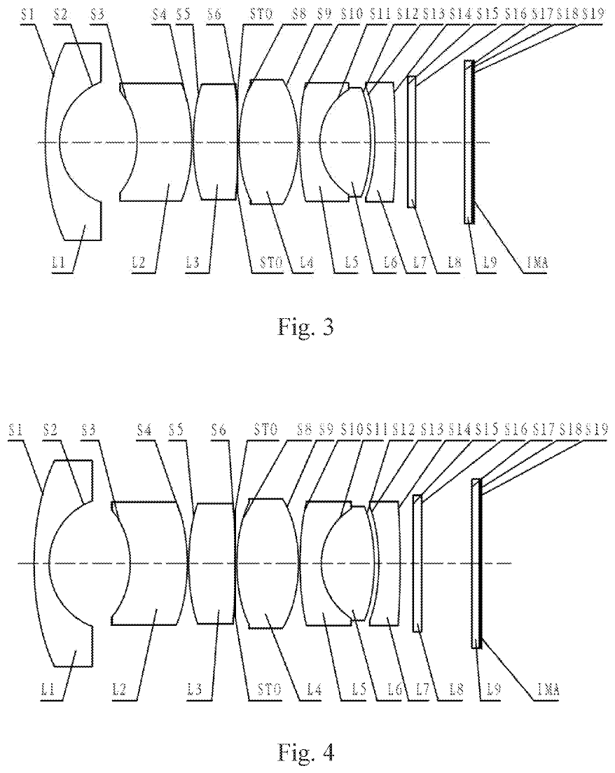

An optical lens assembly according to Embodiment 3 of the present disclosure is described below with reference to FIG. 3. FIG. 3 is a schematic structural diagram of the optical lens assembly according to Embodiment 3 of the present disclosure.

As shown in FIG. 3, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a convex-concave lens having a negative refractive power, an object-side surface S10 of the fifth lens L5 is a convex surface, and an image-side surface S11 of the fifth lens L5 is a concave surface. The sixth lens L6 is a dual-convex lens having a positive refractive power, an object-side surface S11 of the sixth lens L6 is a convex surface, and an image-side surface S12 of the sixth lens L6 is a convex surface. The seventh lens L7 has a negative refractive power and is a concave-convex lens at an area near the optical axis, an object-side surface S13 of the seventh lens L7 is a concave surface at the area near the optical axis, and an image-side surface S14 of the seventh lens L7 is a convex surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the image-side surface S6 of the third lens L3.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 5 shows a radius of curvature R, a thickness d/distance T, a refractive index Nd and an abbe number Vd of each lens of the optical lens assembly in Embodiment 3. Table 6 shows the conic coefficients and the high-order coefficients applicable to the aspheric surfaces in Embodiment 3. Here, the surface type of each aspheric surface may be defined using the formula (1) given in Embodiment 1.

TABLE 5

| | radius of | thickness d/ | refractive | abbe |
|---|---|---|---|---|
| surface | curvature R | distance T | index | number |
| number | (mm) | (mm) | Nd | Vd |
| S1 | 17.5069 | 0.9800 | 1.80 | 46.57 |
| S2 | 4.3691 | 5.2895 | | |
| S3 | −5.6849 | 3.7180 | 1.75 | 52.34 |
| S4 | −11.5768 | 0.1000 | | |
| S5 | 17.2805 | 3.0261 | 1.69 | 31.08 |
| S6 | −18.4474 | 0.0000 | | |
| STO | infinite | 0.1000 | | |
| S8 | 10.3344 | 4.0204 | 1.59 | 68.35 |
| S9 | −9.1116 | 0.1000 | | |
| S10 | 19.4281 | 1.3834 | 1.85 | 23.79 |
| S11 | 4.2381 | 3.4498 | 1.50 | 81.61 |
| S12 | −11.1469 | 0.3003 | | |
| S13 | −10.9607 | 1.3881 | 1.69 | 31.08 |
| S14 | −28.9223 | 0.8500 | | |
| S15 | infinite | 0.5500 | 1.52 | 64.21 |
| S16 | infinite | 3.3264 | | |
| S17 | infinite | 0.5000 | 1.52 | 64.21 |
| S18 | infinite | 0.1250 | | |
| S19(IMA) | infinite | — | | |

TABLE 6

| surface | | | | | | | | |
|---|---|---|---|---|---|---|---|---|
| number | k | A4 | A6 | A8 | A10 | A12 | A14 | A16 |
| S5 | 0.0597 | 3.0105E−04 | 1.6696E−05 | 2.6108E−07 | −2.2591E−08 | −3.5904E−11 | 1.9158E−13 | 3.0833E−13 |
| S6 | 0.0877 | 1.0143E−03 | 2.2200E−05 | 1.0121E−06 | −1.3231E−08 | 7.4927E−11 | 3.8505E−13 | −8.6678E−13 |
| S13 | −3.3721 | 9.3152E−05 | 2.8075E−05 | −4.6833E−06 | 4.6753E−07 | −4.9041E−08 | 2.3308E−09 | −3.5991E−11 |
| S14 | −97.7499 | 1.8929E−04 | 9.6972E−05 | −1.2301E−05 | 4.3726E−07 | 4.5116E−08 | −5.4718E−09 | 1.5840E−10 |

### Embodiment 4

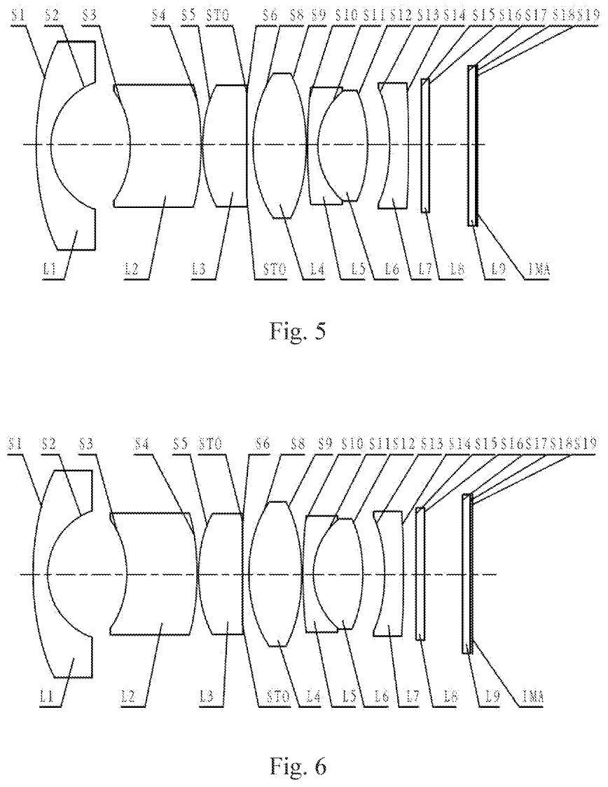

An optical lens assembly according to Embodiment 4 of the present disclosure is described below with reference to FIG. 4. FIG. 4 is a schematic structural diagram of the optical lens assembly according to Embodiment 4 of the present disclosure.

As shown in FIG. 4, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a convex-concave lens having a negative refractive power, an object-side surface S10 of the fifth lens L5 is a convex surface, and an image-side surface S11 of the fifth lens L5 is a concave surface. The sixth lens L6 is a dual-convex lens having a positive refractive power, an object-side surface S11 of the sixth lens L6 is a convex surface, and an image-side surface S12 of the sixth lens L6 is a convex surface. The seventh lens L7 has a negative refractive power and is a concave-convex lens at an area near the optical axis, an object-side surface S13 of the seventh lens L7 is a concave surface at the area near the optical axis, and an image-side surface S14 of the seventh lens L7 is a convex surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the image-side surface S6 of the third lens L3.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 7 shows a radius of curvature R, a thickness d/distance T, a refractive index Nd and an abbe number Vd of each lens of the optical lens assembly in Embodiment 4. Table 8 shows the conic coefficients and the high-order coefficients applicable to the aspheric surfaces in Embodiment 4. Here, the surface type of each aspheric surface may be defined using the formula (1) given in Embodiment 1.

TABLE 7

| | radius of | thickness d/ | refractive | abbe |
|---|---|---|---|---|
| surface | curvature R | distance T | index | number |
| number | (mm) | (mm) | Nd | Vd |
| S1 | 17.5193 | 0.9800 | 1.80 | 46.57 |
| S2 | 4.3699 | 5.2894 | | |
| S3 | −5.6838 | 3.7177 | 1.75 | 52.34 |
| S4 | −11.5770 | 0.1000 | | |
| S5 | 17.2758 | 3.0284 | 1.69 | 31.08 |
| S6 | −18.4573 | 0.0000 | | |
| STO | infinite | 0.1082 | | |
| S8 | 10.3398 | 4.0201 | 1.59 | 68.35 |
| S9 | −9.1093 | 0.1000 | | |
| S10 | 19.4294 | 1.3831 | 1.85 | 23.79 |
| S11 | 4.2378 | 3.4502 | 1.50 | 81.61 |
| S12 | −11.1424 | 0.3004 | | |
| S13 | −10.9559 | 1.3884 | 1.69 | 31.08 |
| S14 | −29.0497 | 0.8500 | | |
| S15 | infinite | 0.5500 | 1.52 | 64.21 |
| S16 | infinite | 3.2832 | | |
| S17 | infinite | 0.5000 | 1.52 | 64.21 |
| S18 | infinite | 0.1250 | | |
| S19(IMA) | infinite | — | | |

TABLE 8

| surface | | | | | | | | |
|---|---|---|---|---|---|---|---|---|
| number | k | A4 | A6 | A8 | A10 | A12 | A14 | A16 |
| S5 | 0.1634 | 3.0319E−04 | 1.6667E−05 | 2.5357E−07 | −2.2751E−08 | −3.1290E−11 | 2.0776E−12 | 3.9502E−13 |
| S6 | 0.1627 | 1.0131E−03 | 2.2329E−05 | 1.0328E−06 | −1.1342E−08 | 1.6492E−10 | −3.8693E−12 | −2.5414E−12 |
| S13 | −3.3856 | 9.3696E−05 | 2.7574E−05 | −4.7256E−06 | 4.6832E−07 | −4.8790E−08 | 2.3470E−09 | −3.5083E−11 |
| S14 | −96.3054 | 1.8717E−04 | 9.6892E−05 | −1.2309E−05 | 4.3641E−07 | 4.5115E−08 | −5.4634E−09 | 1.5934E−10 |

### Embodiment 5

An optical lens assembly according to Embodiment 5 of the present disclosure is described below with reference to FIG. 5. FIG. 5 is a schematic structural diagram of the optical lens assembly according to Embodiment 5 of the present disclosure.

As shown in FIG. 5, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a convex-concave lens having a negative refractive power, an object-side surface S10 of the fifth lens L5 is a convex surface, and an image-side surface S11 of the fifth lens L5 is a concave surface. The sixth lens L6 is a dual-convex lens having a positive refractive power, an object-side surface S11 of the sixth lens L6 is a convex surface, and an image-side surface S12 of the sixth lens L6 is a convex surface. The seventh lens L7 has a negative refractive power and is a dual-concave lens at an area near the optical axis, an object-side surface S13 of the seventh lens L7 is a concave surface at the area near the optical axis, and an image-side surface S14 of the seventh lens L7 is a concave surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the image-side surface S6 of the third lens L3.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 9 shows a radius of curvature R, a thickness d/distance T, a refractive index Nd and an abbe number Vd of each lens of the optical lens assembly in Embodiment 5. Table 10 shows the conic coefficients and the high-order coefficients applicable to the aspheric surfaces in Embodiment 5. Here, the surface type of each aspheric surface may be defined using the formula (1) given in Embodiment 1.

TABLE 9

| | radius of | thickness d/ | refractive | abbe |
|---|---|---|---|---|
| surface | curvature R | distance T | index | number |
| number | (mm) | (mm) | Nd | Vd |
| S1 | 17.5022 | 0.9800 | 1.80 | 46.57 |
| S2 | 4.5150 | 5.3030 | | |
| S3 | −6.5779 | 4.7166 | 1.80 | 39.64 |
| S4 | −16.1188 | 0.1000 | | |
| S5 | 11.1532 | 2.9508 | 1.69 | 31.08 |
| S6 | −26.6895 | 0.0000 | | |
| STO | infinite | 0.4138 | | |
| S8 | 9.2438 | 3.5505 | 1.59 | 68.35 |
| S9 | −11.5758 | 0.0836 | | |
| S10 | 34.9579 | 0.6924 | 1.85 | 23.79 |
| S11 | 4.8630 | 3.3153 | 1.50 | 81.59 |
| S12 | −9.6093 | 1.4709 | | |
| S13 | −28.9562 | 1.2530 | 1.69 | 31.08 |
| S14 | 32.5511 | 0.8500 | | |
| S15 | infinite | 0.5500 | 1.52 | 64.21 |
| S16 | infinite | 2.5846 | | |
| S17 | infinite | 0.5000 | 1.52 | 64.21 |
| S18 | infinite | 0.1250 | | |
| S19(IMA) | infinite | — | | |

TABLE 10

| surface | | | | | | | | |
|---|---|---|---|---|---|---|---|---|
| number | k | A4 | A6 | A8 | A10 | A12 | A14 | A16 |
| S5 | −0.0301 | 3.3347E−04 | 1.8199E−05 | −1.2524E−08 | −6.6174E−09 | 5.4844E−10 | 7.9526E−11 | −5.2644E−12 |
| S6 | −1.2177 | 1.1053E−03 | 2.6998E−05 | 4.5851E−07 | 2.7914E−08 | 6.4324E−10 | 3.4581E−11 | −8.7342E−12 |
| S13 | 2.3184 | −3.0029E−03 | 7.8319E−05 | −2.8484E−06 | 5.0685E−07 | −5.9685E−08 | 1.0203E−09 | 6.5354E−11 |
| S14 | −99.4410 | −2.2247E−03 | 1.4415E−04 | −1.0995E−05 | 4.2939E−07 | 4.1401E−08 | −5.4879E−09 | 1.6799E−10 |

### Embodiment 6

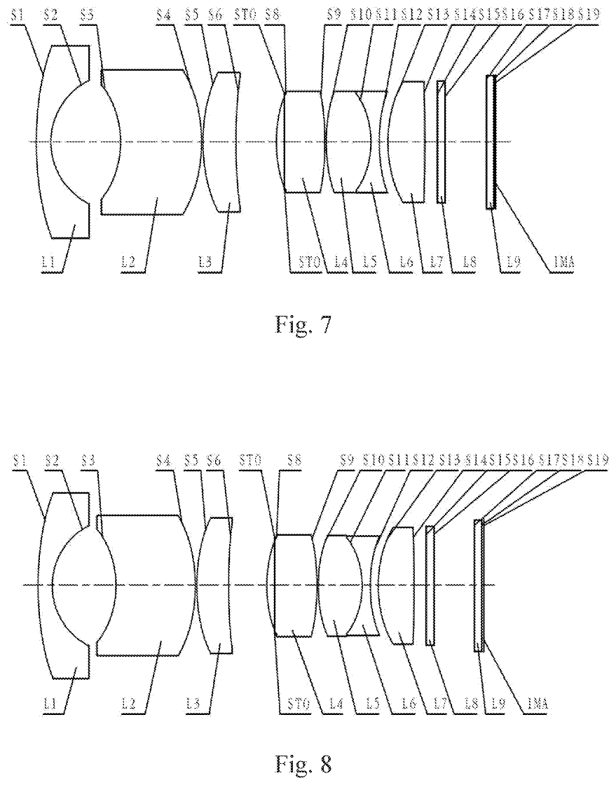

An optical lens assembly according to Embodiment 6 of the present disclosure is described below with reference to FIG. 6. FIG. 6 is a schematic structural diagram of the optical lens assembly according to Embodiment 6 of the present disclosure.

As shown in FIG. 6, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a dual-convex lens having a positive refractive power, an object-side surface S5 of the third lens L3 is a convex surface, and an image-side surface S6 of the third lens L3 is a convex surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a convex-concave lens having a negative refractive power, an object-side surface S10 of the fifth lens L5 is a convex surface, and an image-side surface S11 of the fifth lens L5 is a concave surface. The sixth lens L6 is a dual-convex lens having a positive refractive power, an object-side surface S11 of the sixth lens L6 is a convex surface, and an image-side surface S12 of the sixth lens L6 is a convex surface. The seventh lens L7 has a negative refractive power and is a dual-concave lens at an area near the optical axis, an object-side surface S13 of the seventh lens L7 is a concave surface at the area near the optical axis, and an image-side surface S14 of the seventh lens L7 is a concave surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the image-side surface S6 of the third lens L3.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 11 shows a radius of curvature R, a thickness d/distance T, a refractive index Nd and an abbe number Vd of each lens of the optical lens assembly in Embodiment 6. Table 12 shows the conic coefficients and the high-order coefficients applicable to the surfaces in Embodiment 6. Here, the surface type of each aspheric surface may be defined using the formula (1) given in Embodiment 1.

TABLE 11

| | radius of | thickness d/ | refractive | abbe |
|---|---|---|---|---|
| surface | curvature R | distance T | index | number |
| number | (mm) | (mm) | Nd | Vd |
| S1 | 17.5017 | 0.9800 | 1.80 | 46.57 |
| S2 | 4.5150 | 5.3029 | | |
| S3 | −6.5780 | 4.7166 | 1.80 | 39.64 |
| S4 | −16.1174 | 0.1000 | | |
| S5 | 11.1546 | 2.9519 | 1.69 | 31.08 |
| S6 | −26.6781 | 0.0000 | | |
| STO | infinite | 0.4172 | | |
| S8 | 9.2451 | 3.5506 | 1.59 | 68.35 |
| S9 | −11.5767 | 0.0836 | | |
| S10 | 34.9645 | 0.6925 | 1.85 | 23.79 |
| S11 | 4.8631 | 3.3155 | 1.50 | 81.59 |
| S12 | −9.6080 | 1.4710 | | |
| S13 | −28.9526 | 1.2533 | 1.69 | 31.08 |
| S14 | 32.5392 | 0.8500 | | |
| S15 | infinite | 0.5500 | 1.52 | 64.21 |
| S16 | infinite | 2.5847 | | |
| S17 | infinite | 0.5000 | 1.52 | 64.21 |
| S18 | infinite | 0.1250 | | |
| S19(IMA) | infinite | — | | |

TABLE 12

| surface | | | | | | | | |
|---|---|---|---|---|---|---|---|---|
| number | k | A4 | A6 | A8 | A10 | A12 | A14 | A16 |
| S5 | −0.0267 | 3.3381E−04 | 1.8240E−05 | −1.0066E−08 | −6.5198E−09 | 5.4946E−10 | 7.9212E−11 | −5.3080E−12 |
| S6 | −1.2763 | 1.1057E−03 | 2.7023E−05 | 4.6159E−07 | 2.8185E−08 | 6.5423E−10 | 3.3897E−11 | −8.9138E−12 |
| S13 | 2.2144 | −3.0023E−03 | 7.8357E−05 | −2.8476E−06 | 5.0656E−07 | −5.9751E−08 | 1.0149E−09 | 6.7047E−11 |
| S14 | −99.7213 | −2.2251E−03 | 1.4412E−04 | −1.0997E−05 | 4.2932E−07 | 4.1402E−08 | −5.4869E−09 | 1.6814E−10 |

### Embodiment 7

An optical lens assembly according to Embodiment 7 of the present disclosure is described below with reference to FIG. 7. FIG. 7 is a schematic structural diagram of the optical lens assembly according to Embodiment 7 of the present disclosure.

As shown in FIG. 7, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a convex-concave lens having a positive refractive power, an object-side surface S5 of the third lens L3 is a convex surface, and an image-side surface S6 of the third lens L3 is a concave surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a dual-convex lens having a positive refractive power, an object-side surface S10 of the fifth lens L5 is a convex surface, and an image-side surface S11 of the fifth lens L5 is a convex surface. The sixth lens L6 is a dual-concave lens having a negative refractive power, an object-side surface S11 of the sixth lens L6 is a concave surface, and an image-side surface S12 of the sixth lens L6 is a concave surface. The seventh lens L7 has a positive refractive power and is a dual-convex lens at an area near the optical axis, an object-side surface S13 of the seventh lens L7 is a convex surface at the area near the optical axis, and an image-side surface S14 of the seventh lens L7 is a convex surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the object-side surface S8 of the fourth lens L4.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 13 shows a radius of curvature R, a thickness d/distance T, a refractive index Nd and an abbe number Vd of each lens of the optical lens assembly in Embodiment 7. Table 14 shows the conic coefficients and the high-order coefficients applicable to the aspheric surfaces in Embodiment 7. Here, the surface type of each aspheric surface may be defined using the formula (1) given in Embodiment 1.

TABLE 13

| | radius of | thickness d/ | refractive | abbe |
|---|---|---|---|---|
| surface | curvature R | distance T | index | number |
| number | (mm) | (mm) | Nd | Vd |
| S1 | 20.8305 | 0.9954 | 1.91 | 35.26 |
| S2 | 4.7207 | 4.7616 | | |
| S3 | −6.8829 | 5.5414 | 1.81 | 41.00 |
| S4 | −9.6495 | 0.1007 | | |
| S5 | 11.4978 | 2.2506 | 1.88 | 39.23 |
| S6 | 35.0026 | 3.3183 | | |
| STO | infinite | −0.5540 | | |
| S8 | 8.9263 | 3.3102 | 1.50 | 81.59 |
| S9 | −18.8726 | 0.1007 | | |
| S10 | 11.1134 | 3.0556 | 1.44 | 95.10 |
| S11 | −5.9529 | 0.5676 | 1.85 | 23.79 |
| S12 | 10.9063 | 0.5933 | | |
| S13 | 9.2827 | 2.5217 | 1.81 | 41.00 |
| S14 | −25.0307 | 0.8500 | | |
| S15 | infinite | 0.5500 | 1.52 | 64.21 |
| S16 | infinite | 2.8200 | | |
| S17 | infinite | 0.5000 | 1.52 | 64.21 |
| S18 | infinite | 0.1250 | | |
| S19(IMA) | infinite | — | | |

TABLE 14

| surface | | | | | | | | |
|---|---|---|---|---|---|---|---|---|
| number | k | A4 | A6 | A8 | A10 | A12 | A14 | A16 |
| S3 | 0.7543 | 7.3103E−06 | 1.2184E−05 | −1.0987E−06 | 1.4900E−07 | −1.0729E−08 | 4.1815E−10 | −6.6247E−12 |
| S4 | −0.4831 | −1.6155E−06 | 1.6547E−06 | 8.0698E−08 | −1.0075E−08 | 5.1438E−10 | −1.1829E−11 | 1.0567E−13 |
| S13 | −3.5799 | 1.4352E−04 | 2.0776E−05 | −8.6370E−07 | 4.1368E−07 | −4.4832E−08 | 2.1298E−09 | −3.4732E−11 |
| S14 | −201.6206 | −1.2332E−03 | 1.9847E−04 | −1.5638E−05 | 6.2622E−07 | 4.1842E−08 | −4.9371E−09 | 1.4125E−10 |

### Embodiment 8

An optical lens assembly according to Embodiment 8 of the present disclosure is described below with reference to FIG. 8. FIG. 8 is a schematic structural diagram of the optical lens assembly according to Embodiment 8 of the present disclosure.

As shown in FIG. 8, the optical lens assembly includes, sequentially along an optical axis from an object side to an image side, a first lens L1, a second lens L2, a third lens L3, a fourth lens L4, a fifth lens L5, a sixth lens L6 and a seventh lens L7.

The first lens L1 is a convex-concave lens having a negative refractive power, an object-side surface S1 of the first lens L1 is a convex surface, and an image-side surface S2 of the first lens L1 is a concave surface. The second lens L2 is a concave-convex lens having a negative refractive power, an object-side surface S3 of the second lens L2 is a concave surface, and an image-side surface S4 of the second lens L2 is a convex surface. The third lens L3 is a convex-concave lens having a positive refractive power, an object-side surface S5 of the third lens L3 is a convex surface, and an image-side surface S6 of the third lens L3 is a concave surface. The fourth lens L4 is a dual-convex lens having a positive refractive power, an object-side surface S8 of the fourth lens L4 is a convex surface, and an image-side surface S9 of the fourth lens L4 is a convex surface. The fifth lens L5 is a dual-convex lens having a positive refractive power, an object-side surface S10 of the fifth lens L5 is a convex surface, and an image-side surface S11 of the fifth lens L5 is a convex surface. The sixth lens L6 is a dual-concave lens having a negative refractive power, an object-side surface S11 of the sixth lens L6 is a concave surface, and an image-side surface S12 of the sixth lens L6 is a concave surface. The seventh lens L7 has a positive refractive power and is a dual-convex lens at an area near the optical axis, an object-side surface S13 of the seventh lens L7 is a convex surface at the area near the optical axis, and an image-side surface S14 of the seventh lens L7 is a convex surface at the area near the optical axis. The fifth lens L5 and the sixth lens L6 can be cemented to form a cemented lens.

The optical lens assembly may further include a diaphragm STO, and the diaphragm STO may be disposed between the third lens L3 and the fourth lens L4 to improve the imaging quality. For example, the diaphragm STO may be disposed near the object-side surface S8 of the fourth lens L4.

Alternatively, the optical lens assembly may further include an optical filter L8 having an object-side surface S15 and an image-side surface S16. The optical filter L8 may be used to correct color deviations. The optical lens assembly may further include a protective glass L9 having an object-side surface S17 and an image-side surface S18. The protective glass L9 may be used to protect an image sensing chip IMA at an image plane S19. Light from an object sequentially passes through the surfaces S1-S18 and finally forms an image on the image plane S19.

Table 15 shows a radius of curvature R, a thickness d/distance T, a refractive index Nd and an abbe number Vd of each lens of the optical lens assembly in Embodiment 8. Table 16 shows the conic coefficients and the high-order coefficients applicable to the aspheric surfaces in Embodiment 8. Here, the surface type of each aspheric surface may be defined using the formula (1) given in Embodiment 1.

TABLE 15

| | radius of | thickness d/ | refractive | abbe |
|---|---|---|---|---|
| surface | curvature R | distance T | index | number |
| number | (mm) | (mm) | Nd | Vd |
| S1 | 20.5527 | 0.9788 | 1.91 | 35.26 |
| S2 | 4.6941 | 4.4332 | | |
| S3 | −6.7039 | 5.5129 | 1.81 | 41.00 |
| S4 | −9.8653 | 0.0991 | | |
| S5 | 11.9685 | 2.2082 | 1.88 | 39.23 |
| S6 | 37.9183 | 3.2000 | | |
| STO | infinite | −0.5448 | | |
| S8 | 8.8104 | 3.4785 | 1.50 | 81.59 |
| S9 | −15.8416 | 0.0991 | | |
| S10 | 9.7830 | 3.0502 | 1.44 | 95.10 |
| S11 | −5.7554 | 0.5581 | 1.85 | 23.79 |
| S12 | 9.5351 | 0.5587 | | |
| S13 | 9.0692 | 2.4798 | 1.81 | 41.00 |
| S14 | −23.7989 | 0.8500 | | |
| S15 | infinite | 0.5500 | 1.52 | 64.21 |
| S16 | infinite | 2.8137 | | |
| S17 | infinite | 0.5000 | 1.52 | 64.21 |
| S18 | infinite | 0.1250 | | |
| S19(IMA) | infinite | — | | |

TABLE 16

| surface | | | | | | | | |
|---|---|---|---|---|---|---|---|---|
| number | k | A4 | A6 | A8 | A10 | A12 | A14 | A16 |
| S3 | 0.5823 | 2.1965E−05 | 1.5006E−05 | −1.1474E−06 | 1.7343E−07 | −1.2831E−08 | 5.3202E−10 | −8.9717E−12 |
| S4 | −0.3898 | 7.5912E−06 | 2.3074E−06 | 1.1187E−07 | −1.1075E−08 | 6.2576E−10 | −1.5784E−11 | 1.6764E−13 |
| S13 | −3.9514 | 1.8376E−04 | 2.7235E−05 | −1.0221E−06 | 4.7168E−07 | −5.3546E−08 | 2.6849E−09 | −4.5757E−11 |
| S14 | −199.1274 | −1.4416E−03 | 2.2392E−04 | −1.7473E−05 | 7.1767E−07 | 4.9303E−08 | −6.1448E−09 | 1.8796E−10 |

In summary, Embodiments 1-8 respectively satisfy the relationships shown in the following tables 17-1 and 17-2. In Tables 17-1 and 17-2, the units of TTL, F, H, D, F−, F+, F7, F1, F2, F3, F4, T67, R3, R4, d3, D3, D4, SAG3 and SAG4 are millimeters (mm), and the unit of FOV is degrees (°).

TABLE 17-1

| | embodiment | | | |
|---|---|---|---|---|
| conditional | embodi- | embodi- | embodi- | embodi- |
| expression | ment 1 | ment 2 | ment 3 | ment 4 |
| TTL | 30.2622 | 29.6921 | 29.2070 | 29.174 |
| F | 4.0000 | 4.0917 | 4.1496 | 4.1468 |
| H | 9.3000 | 9.1320 | 10.0660 | 10.0520 |
| FOV | 140 | 140 | 140 | 140 |
| D | 13.6959 | 13.7173 | 13.4106 | 13.4248 |
| F− | −4.7301 | −4.6627 | −6.6239 | −6.6231 |
| F+ | 7.0522 | 6.9561 | 6.6588 | 6.6579 |
| F7 | 59.0309 | 60.2297 | −26.2769 | −26.1821 |
| SAG3/D3 | −0.2914 | −0.3006 | −0.3408 | −0.3424 |
| SAG4/D4 | −0.2169 | −0.2126 | −0.1787 | −0.1786 |
| F1 | −7.1279 | −7.0366 | −7.4568 | −7.4566 |
| F2 | −79.1759 | −80.9175 | −19.8473 | −20.2327 |
| F3 | 12.7109 | 12.5174 | 13.3259 | 13.3278 |
| F4 | 9.9132 | 9.7727 | 8.8233 | 8.8241 |
| TTL/F | 7.5656 | 7.2566 | 7.0384 | 7.0352 |
| TTL/H/FOV | 0.0232 | 0.0232 | 0.0207 | 0.0207 |
| D/H/FOV | 0.0105 | 0.0107 | 0.0095 | 0.0095 |
| \|F+/F−\| | 1.4909 | 1.4919 | 1.0053 | 1.0053 |
| \|F7/F\| | 14.7577 | 14.7199 | 6.3323 | 6.3137 |
| T67/TTL | 0.0342 | 0.0345 | 0.0103 | 0.0103 |
| \|R3 − R4 − d3\|(mm) | 1.9731 | 2.0107 | 2.1740 | 2.1755 |
| d3/TTL | 0.1870 | 0.1879 | 0.1273 | 0.1274 |
| (FOV × F)/H | 60.2151 | 62.7291 | 57.7140 | 57.7554 |
| arctan(SAG3/D3)/ | 1.3277 | 1.3940 | 1.8570 | 1.8664 |
| arctan(SAG4/D4) | | | | |
| Vd+/Nd+ | 54.6150 | 54.6150 | 54.5146 | 54.5146 |

TABLE 17-2

| | embodiment | | | |
|---|---|---|---|---|
| conditional | embodi- | embodi- | embodi- | embodi- |
| expression | ment 5 | ment 6 | ment 7 | ment 8 |
| TTL | 29.4396 | 29.4449 | 31.4080 | 30.9504 |
| F | 4.1765 | 4.1768 | 3.9700 | 3.9950 |
| H | 10.0000 | 10.0000 | 9.0740 | 9.1140 |
| FOV | 140 | 140 | 140 | 140 |
| D | 13.8885 | 13.8886 | 13.1883 | 12.9191 |
| F− | −6.6772 | −6.6772 | −4.4349 | −4.1280 |
| F+ | 7.0123 | 7.0121 | 9.3589 | 8.7973 |
| F7 | −21.8929 | −21.8876 | 8.5953 | 8.3430 |
| SAG3/D3 | −0.3008 | −0.3008 | −0.3352 | −0.3378 |
| SAG4/D4 | −0.1286 | −0.1286 | −0.2606 | −0.2471 |
| F1 | −7.7921 | −7.7922 | −6.8597 | −6.8363 |
| F2 | −17.6297 | −17.6322 | −292.3025 | −118.2606 |
| F3 | 11.7055 | 11.7054 | 18.4435 | 18.9288 |
| F4 | 9.2268 | 9.2278 | 12.6592 | 11.9178 |
| TTL/F | 7.0489 | 7.0497 | 7.9113 | 7.7473 |
| TTL/H/FOV | 0.0210 | 0.0210 | 0.0247 | 0.0243 |
| D/H/FOV | 0.0099 | 0.0099 | 0.0104 | 0.0101 |
| \|F+/F−\| | 1.0502 | 1.0502 | 2.1103 | 2.1311 |
| \|F7/F\| | 5.2420 | 5.2403 | 2.1651 | 2.0884 |
| T67/TTL | 0.0500 | 0.0500 | 0.0189 | 0.0181 |
| \|R3 − R4 − d3\|(mm) | 4.8242 | 4.8227 | 2.7747 | 2.3515 |
| d3/TTL | 0.1602 | 0.1602 | 0.1764 | 0.1781 |
| (FOV × F)/H | 58.4706 | 58.4749 | 61.2519 | 61.3671 |
| arctan(SAG3/D3)/ | 2.2846 | 2.2843 | 1.2685 | 1.3446 |
| arctan(SAG4/D4) | | | | |
| Vd+/Nd+ | 54.5056 | 54.5056 | 66.1798 | 66.1798 |

The present disclosure further provides an electronic device, which may include the optical lens assembly according to the above embodiments of the present disclosure and an imaging element used to convert an optical image formed by the optical lens assembly into an electrical signal. The electronic device may be an independent electronic device such as a detection distance camera, or may be an imaging module integrated into, for example, a detection distance device. In addition, the electronic device may be an independent imaging device such as a vehicle-mounted camera, or may be an imaging module integrated into, for example, a driving assistance system.

The foregoing is only a description for the preferred embodiments of the present disclosure and the applied technical principles. It should be appreciated by those skilled in the art that the scope of the present disclosure is not limited to the technical solution formed by the particular combination of the above technical features. The scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical lens assembly, comprising, sequentially along an optical axis from an object side to an image side:
a first lens, having a negative refractive power, an object-side surface of the first lens being a convex surface, and an image-side surface of the first lens being a concave surface;
a second lens, having a negative refractive power, an object-side surface of the second lens being a concave surface, and an image-side surface of the second lens being a convex surface;
a third lens, having a positive refractive power, an object-side surface of the third lens being a convex surface;
a fourth lens, having a positive refractive power, an object-side surface of the fourth lens being a convex surface, and an image-side surface of the fourth lens being a convex surface;
a fifth lens, having a refractive power;
a sixth lens, having a refractive power; and
a seventh lens, having a refractive power,
wherein one of the fifth lens and the sixth lens has a positive refractive power, an other one of the fifth lens and the sixth lens has a negative refractive power, and the fifth lens and the sixth lens are cemented to form a cemented lens.

2. The optical lens assembly according to claim 1, wherein an image-side surface of the third lens is a convex surface or a concave surface.

3. The optical lens assembly according to claim 1, wherein the fifth lens has a negative refractive power, an object-side surface of the fifth lens is a concave surface or a convex surface, and an image-side surface of the fifth lens is a concave surface; or the fifth lens has a positive refractive power, the object-side surface of the fifth lens is a convex surface, and the image-side surface of the fifth lens is a convex surface.

4. The optical lens assembly according to claim 1, wherein the sixth lens has a positive refractive power, an object-side surface of the sixth lens is a convex surface, and an image-side surface of the sixth lens is a convex surface; or the sixth lens has a negative refractive power, the object-side surface of the sixth lens is a concave surface, and the image-side surface of the sixth lens is a concave surface.

5. The optical lens assembly according to claim 1, wherein the seventh lens has a positive refractive power, an object-side surface of the seventh lens is a convex surface at an area near the optical axis, and an image-side surface of the seventh lens is a concave surface or a convex surface at the area near the optical axis; or the seventh lens has a negative refractive power, the object-side surface of the seventh lens is a concave surface at the area near the optical axis, and the image-side surface of the seventh lens is a concave surface or a convex surface at the area near the optical axis; and the object-side surface of the seventh lens and the image-side surface of the seventh lens at least have one inflection point.

6. The optical lens assembly according to claim 1, wherein at least two of the second lens, the third lens, the fourth lens and the seventh lens have an aspheric surface.

7. The optical lens assembly according to claim 1, wherein a distance TTL from the object-side surface of the first lens to an image plane of the optical lens assembly on the optical axis and a total effective focal length F of the optical lens assembly satisfy: TTL/F≤9.

8. The optical lens assembly according to claim 1, wherein the distance TTL from the object-side surface of the first lens to the image plane of the optical lens assembly on the optical axis, an image height H corresponding to a maximal field-of-view FOV of the optical lens assembly and the maximal field-of-view FOV of the optical lens assembly satisfy: TTL/H/FOV≤0.1.

9. The optical lens assembly according to claim 1, wherein the maximal field-of-view FOV of the optical lens assembly, a maximal aperture D of the object-side surface of the first lens corresponding to the maximal field-of-view of the optical lens assembly and the image height H corresponding to the maximal field-of-view of the optical lens assembly satisfy: D/H/FOV≤0.025.

10. The optical lens assembly according to claim 1, wherein an effective focal length F+ of a lens having a positive refractive power in the cemented lens and an effective focal length F− of a lens having a negative refractive power in the cemented lens satisfy: 0.5≤|F+/F−|≤3.

11. The optical lens assembly according to claim 1, wherein an effective focal length F7 of the seventh lens and the total effective focal length F of the optical lens assembly satisfy: |F7/F|≥1.5.

12. The optical lens assembly according to claim 1, wherein a spacing distance T67 between the sixth lens and the seventh lens on the optical axis and the distance TTL from the object-side surface of the first lens to the image plane of the optical lens assembly on the optical axis satisfy: 0≤T67/TTL≤0.2.

13. The optical lens assembly according to claim 1, wherein a radius of curvature R3 of the object-side surface of the second lens, a radius of curvature R4 of the image-side surface of the second lens and a center thickness d3 of the second lens on the optical axis satisfy: |R3−R4−d3|≥1.5 mm.

14. The optical lens assembly according to claim 1, wherein the center thickness d3 of the second lens on the optical axis and the distance TTL from the object-side surface of the first lens to the image plane of the optical lens assembly on the optical axis satisfy: 0.05≤d3/TTL≤0.3.

15. The optical lens assembly according to claim 1, wherein the maximal field-of-view FOV of the optical lens assembly, the total effective focal length F of the optical lens assembly and the image height H corresponding to the maximal field-of-view of the optical lens assembly satisfy: (FOV×F)/H≤70.

16. The optical lens assembly according to claim 1, wherein a semi-diameter D3 of a maximal aperture of the object-side surface of the second lens corresponding to the maximal field-of-view of the optical lens assembly, a distance SAG3 from an intersection point of the object-side surface of the second lens and the optical axis to the maximal aperture of the object-side surface of the second lens on the optical axis, a semi-diameter D4 of a maximal aperture of the image-side surface of the second lens corresponding to the maximal field-of-view of the optical lens assembly, and a distance SAG4 from an intersection point of the image-side surface of the second lens and the optical axis to the maximal aperture of the image-side surface of the second lens on the optical axis satisfy: 0.5≤arctan(SAG3/D3)/arctan(SAG4/D4)≤3.

17. The optical lens assembly according to claim 1, wherein a refractive index Nd+ of the lens having the positive refractive power in the cemented lens and an abbe number Vd+ of the lens having the positive refractive power in the cemented lens satisfy: Vd+/Nd+≥40.

18. An optical lens assembly, comprising, sequentially along an optical axis from an object side to an image side:
a first lens, having a negative refractive power, an object-side surface of the first lens being a convex surface, and an image-side surface of the first lens being a concave surface;
a second lens, having a negative refractive power, an object-side surface of the second lens being a concave surface, and an image-side surface of the second lens being a convex surface;
a third lens, having a positive refractive power, an object-side surface of the third lens being a convex surface;
a fourth lens, having a positive refractive power, an object-side surface of the fourth lens being a convex surface, and an image-side surface of the fourth lens being a convex surface;
a fifth lens, having a refractive power;
a sixth lens, having a refractive power; and
a seventh lens, having a refractive power,
wherein a spacing distance T67 between the sixth lens and the seventh lens on the optical axis and a distance TTL from the object-side surface of the first lens to an image plane of the optical lens assembly on the optical axis satisfy: 0≤T67/TTL≤0.2.

19. The optical lens assembly according to claim 18, wherein one of the fifth lens and the sixth lens has a positive refractive power, an other one of the fifth lens and the sixth lens has a negative refractive power, and the fifth lens and the sixth lens are cemented to form a cemented lens.

20. An electronic device, comprising the optical lens assembly and an imaging element used to convert an optical image formed by the optical lens assembly into an electrical signal;
wherein the optical lens assembly comprises, sequentially along an optical axis from an object side to an image side:
a first lens, having a negative refractive power, an object-side surface of the first lens being a convex surface, and an image-side surface of the first lens being a concave surface;
a second lens, having a negative refractive power, an object-side surface of the second lens being a concave surface, and an image-side surface of the second lens being a convex surface;
a third lens, having a positive refractive power, an object-side surface of the third lens being a convex surface;
a fourth lens, having a positive refractive power, an object-side surface of the fourth lens being a convex surface, and an image-side surface of the fourth lens being a convex surface;
a fifth lens, having a refractive power;
a sixth lens, having a refractive power; and
a seventh lens, having a refractive power,
wherein one of the fifth lens and the sixth lens has a positive refractive power, an other one of the fifth lens and the sixth lens has a negative refractive power, and the fifth lens and the sixth lens are cemented to form a cemented lens.
